(19) United States
(12) Patent Application Publication
(10) Pub. No.: US 2011/0027741 A1
(43) Pub. Date: Feb. 3, 2011

(54) VACUUM-FORMED REFRACTORY MEMBER AND METHOD OF MAKING

(75) Inventors: Thomas E. Klein, North Huntingdon, PA (US); David G. Schalles, Jefferson Hills, PA (US); Robert F. Green, Bethel Park, PA (US); David A. Toocheck, Medina, OH (US)

Correspondence Address: THE WEBB LAW FIRM, P.C., 700 KOPPERS BUILDING, 436 SEVENTH AVENUE, PITTSBURGH, PA, 15219, US

(73) Assignee: BLOOM ENGINEERING COMPANY, INC., Pittsburgh, PA (US)

(21) Appl. No.: 12/933,908

(22) PCT Filed: Mar. 30, 2009
(86) PCT No.: PCT/US09/38738

§ 371 Date: Sep. 22, 2010

(51) Int. Cl. F27D 1/06; F27D 9/00; B29C 41/50; B05D 3/00

(52) U.S. Cl. 432/233; 110/323; 264/101; 427/294

(57) ABSTRACT

A refractory member for use in insulating a support beam or other heat-absorptive element in a high temperature furnace as well as a method of producing such members is provided. The refractory member includes a vacuum-formed refractory shape comprised of a fiber material and at least one binder, a reticulated, interconnected mesh embedded within the refractory shape, and an anchor element for securing the refractory member to the heat-absorptive element.

### CROSS REFERENCE TO RELATED APPLICATIONS

This application claims priority to U.S. Provisional Patent Application No. 61/040,424, filed on Mar. 28, 2008, the contents of which are expressly incorporated herein by reference.

### BACKGROUND OF THE INVENTION

1. Field of the Invention

This invention relates to refractory insulation members for insulating support beams or other heat-absorptive elements in heat-treating furnaces and a method for producing such members. More specifically, the invention relates to vacuum-formed refractory members having a reticulated, interconnected mesh material and an anchor element for securing the member to the heat-absorptive element embedded therein.

2. Description of Related Art

Heat treating furnaces, for example walking beam furnaces or roller hearth furnaces, typically employ support elements, such as water cooled pipes having skid rails or the like, for supporting a work piece as it is conveyed through the furnace. To minimize heat loss from the furnace into the cooling water, the pipes are provided with refractory insulation.

Historically, refractory bricks were used to line the interior surfaces of the furnace walls and for covering support elements to provide the necessary insulation. However, bricks are expensive and replacing them proved to be unduly burdensome and time consuming. More recently, refractory jackets made of ceramic materials have gained favor. The jackets are typically formed in semi-cylindrical pre-cast or pressed segments, or similar configurations, and are joined to one another to encircle the support elements.

U.S. Pat. No. 3,781,167 (Ahonen), for example, discloses no-weld refractory coverings for water cooled pipes wherein metallic straps are anchored and pre-cast into semi-cylindrical insulation segments. The straps have opposing slots on their ends which are intermeshed to hold corresponding insulation segments to one another around a water cooled pipe. As another example, U.S. Pat. No. 4,528,672 (Morgan, II) comprises a refractory shape having an interconnected, reticulated metal mesh defined by a plurality of spirals embedded within the shape.

A known material for refractory covering components is a fiber material disposed in a series of layers to form a fibrous blanket or mat. U.S. Pat. No. 5,010,706 (Sauder), for example, describes a refractory material composed of a ceramic fiber material. One disadvantage of such refractory blankets is that production involves a highly labor intensive process. Alternatively, pre-cast refractory components exist. However, currently known casting methods produce refractory components that are dense and heavy, making shipping and installation difficult.

Despite the recent advancements in the field described above, there continues to be a need in the art for improved refractory members that are lightweight and provide superior insulating properties while remaining inexpensive and easy to assemble.

### SUMMARY OF THE INVENTION

The present invention is directed to a protective refractory member and a method of producing a refractory member.

In one aspect of the present invention, a protective refractory member for protecting a heat-absorptive element in a high-temperature furnace is provided. The refractory member includes a vacuum-formed refractory shape including a fiber material and at least one binder material, an interconnected, reticulated mesh material embedded within the shape, and an anchor element embedded in the refractory shape.

In some non-limiting embodiments, the anchor element may engage the mesh material, such as by being welded to the mesh material. The anchor element may further or alternatively include a lip member that engages the mesh material.

Non-limiting examples of potential fibrous materials include silica, zirconia, alumina, silica-alumina, or combinations thereof. In one non-limiting embodiment, the binder material can be an inorganic binder material.

In some non-limiting embodiments, the refractory member can have a density between 10 and 35 pounds per cubic foot.

The refractory member may further include a coating material applied to at least a portion of an exterior surface of the refractory member. The refractory member can further include at least one receiving space filled with an insert material, which may be in the form of a monolithic block.

In another aspect of the present invention, a method of producing a refractory member is provided. The method includes the steps of providing a mold, placing an interconnected, reticulated mesh material within the mold, forming a slurry comprising a fiber material and at least one binder material, immersing the mold with the mesh material therein into the slurry, subjecting the immersed mold to a vacuum to form a refractory member in the shape of the mold, removing the mold and refractory member from the slurry, separating the refractory member from the mold, and drying the refractory member. In certain non-limiting embodiments, the vacuum can be applied for less than 1 minute and the mold can be a metal screen material.

In some non-limiting embodiments, the method further includes the step of placing an anchor element between openings in the mesh material either before or after subjecting the immersed mold to a vacuum.

In some non-limiting embodiments, the method further includes the step of applying a coating to at least a portion of an exterior surface of the refractory member.

In another aspect of the present invention, a system for insulating a support member in a high-temperature furnace is provided. The system includes a protective refractory member, which is composed of a vacuum-formed refractory shape comprising a fibrous material and at least one binder material, an interconnected, reticulated mesh material embedded within the shape, and an anchor element embedded in the refractory shape. The anchor element is secured to the support member. The anchor element may be secured to the support member by, for example, a weld or a bolt.

In some non-limiting embodiments, the refractory member of the system can further include at least one receiving space filled with an insert material.

These and other features and characteristics of the present invention, as well as the methods of operation and functions of related elements of structures and the combination of parts and economies of manufacture, will become more apparent upon consideration of the following description with reference to the accompanying drawings, which form a part of this specification.

### BRIEF DESCRIPTION OF THE DRAWINGS

FIG. 1 is a perspective view of a refractory member according to the instant invention attached to a heat-absorptive support element;

FIG. 2 is a cross-sectional view of the refractory member and support element of FIG. 1 taken along line A-A. Also shown is a section of the reticulated mesh material embedded within the refractory member;

FIG. 3 is a plan view of the reticulated mesh material showing an anchor element disposed therein;

FIG. 4 is a plan view of the reticulated mesh material showing another embodiment of the anchor element disposed therein;

FIG. 5 is a graph of data collected during heat loss testing; and

FIG. 6 is a block diagram illustrating the steps of producing the refractory member.

### DETAILED DESCRIPTION OF THE PREFERRED EMBODIMENTS

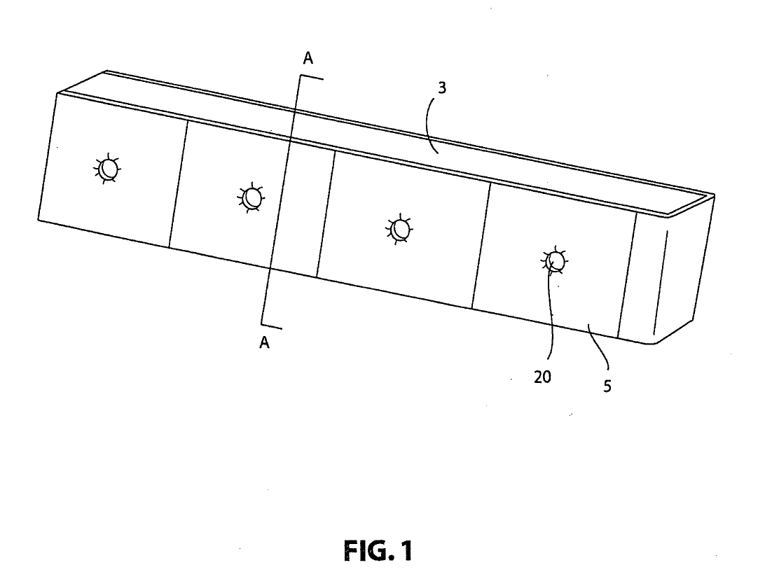

As used herein, spatial or directional terms, such as “left”, “right”, “inner”, “outer”, “above”, “below”, “top”, “bottom”, and the like, relate to the invention as it is shown in FIG. 1. However, it is to be understood that the invention may assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to include the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 5.5 to 10.

The present invention relates to a refractory member and more particularly to a refractory member including an insulation material, a reticulated, interconnected mesh embedded within the member, and an anchor element for securing the refractory member to, e.g., a support element inside a heat treating furnace. The refractory member is “vacuum-formed”, meaning that the insulation material is formed into the shape desired for the refractory member through the use of vacuum pressure.

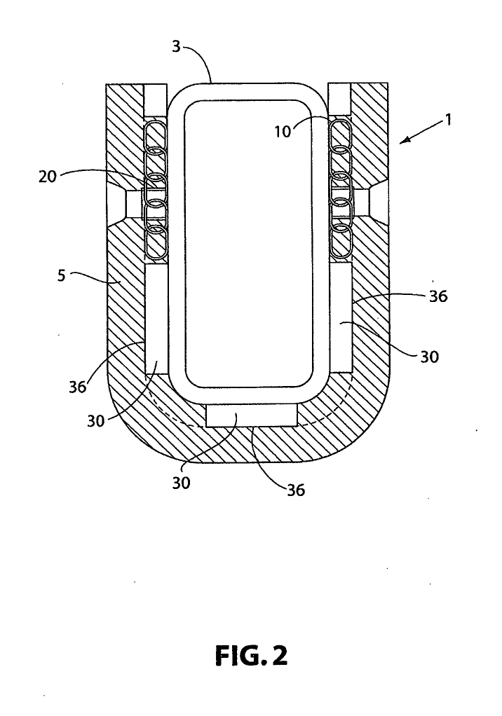

The refractory member can be of any particular shape. The desirability and usefulness of a particular shape depends primarily upon the shape of the heat-absorptive structures to be insulated using the refractory member. For example, to insulate cylindrical support beams, it may be desirable to have a refractory member that is shaped to surround the cylindrical beam either alone or in combination with one or more other members. Also envisioned is a refractory member having a U-shape, as in FIGS. 1-2. Of course, the refractory member can be formed into other shapes without departing from the spirit of the invention.

The refractory member of the present invention includes an insulation material. The insulation material represents the bulk of the volume of the refractory member and provides the member with much of its thermal resistance, thereby limiting the heat transferred between surfaces disposed on opposite sides of the member. The insulation material of the instant invention is generally comprised of a mineral or ceramic fiber material, such as refractory ceramic fibers (RCF), and a binder material. The insulation material may be a mixture of one or more fiber materials in conjunction with a mixture of one or more binder materials. The binder material may be organic or inorganic and is primarily included to improve the handling characteristics of the insulation material. Organic binders generally improve the handling characteristics of the insulation material at low temperatures but burn off at high temperatures. Inorganic binders also improve the handling characteristics of the insulation material and, because they generally do not burn off at high temperatures like organic binders, are particularly desirable in high-temperature refractory members. In formulating the insulation material for a refractory member, it may be particularly useful to include both inorganic and organic binder materials.

Particularly desirable fiber materials for use in the insulating material include silica, zirconia, alumina, silica-alumina, and other like compounds. Of course, combinations of such compounds may also be used. The fiber materials are typically provided in a chopped or loose particulate form. The fiber materials generally comprise between about 90 and 99 weight percent based on the total weight of the refractory member.

Particularly useful inorganic binders include colloidal silica, colloidal alumina, clays, and other like compounds as well as combinations thereof. One example of a useful organic binder material is starch. The binder materials are preferably provided as a loose powder to allow for better dispersion throughout the insulation material. The binder materials generally comprise between about 1 and 10 weight percent based on the total weight of the refractory material.

The insulation material may also include additives such as water, leachable chlorides, or alkalies.

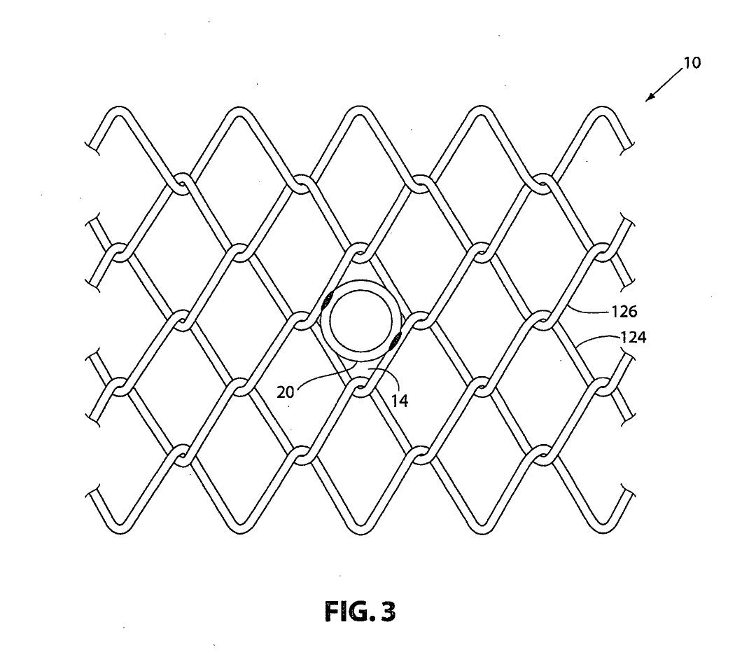

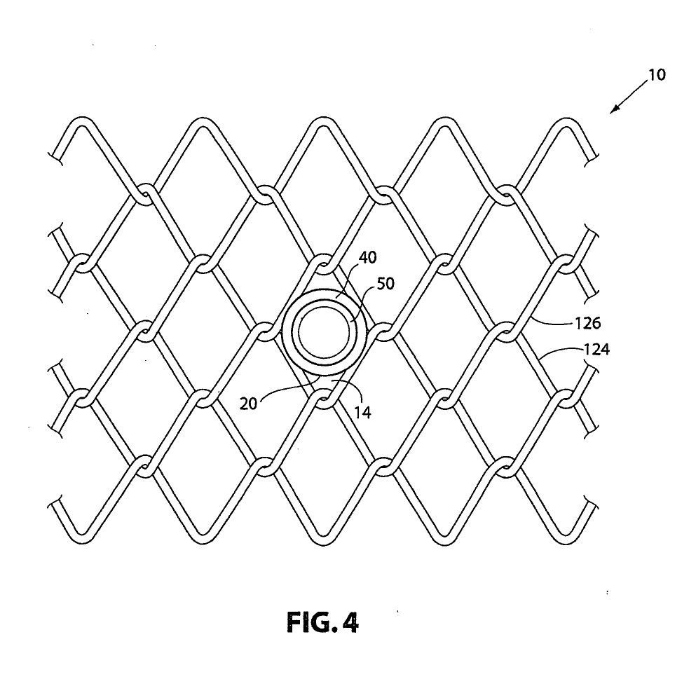

The refractory member may also include, embedded therein, a reticulated, interconnected mesh material, such as that disclosed in U.S. Pat. No. 4,528,672 (Morgan II), which is expressly incorporated herein by reference. The mesh material can be formed from a pair of bent wires interconnected to define a plurality of spirals, as seen in FIGS. 3-4. With reference to FIG. 3, the mesh 10 may be formed by turning or twisting the pair of wires 12a, 12b together such that there are between about 4 and about 7 turns for every 11 inch of wire length. In one embodiment, the mesh material has five and one-half turns for every 11 inch of wire length. The mesh 10 may be comprised of any material known in the art that can withstand high temperatures without suffering degradation in its structural integrity. For example, the mesh 10 may be comprised of a metal, such as stainless steel, carbon steel, or COR-TEN steel. The thickness of the wires may be between 7 gauge and 13 gauge (American wire gauge measurements). Preferably, the spirals are formed to create a series of openings 14 within the mesh 10. The openings 14 are typically between about 1 inch and 2 inch in cross-section. At least a portion of the mesh 10 may be positioned at or near the inner surface of the refractory member 1 which abuts the support element 3 to be protected.

With reference to FIGS. 1-4, the refractory member 1 also includes an anchor element 20 for securing the refractory member 1 to the support element 3. The anchor element 20 can be a tubular member with a hollow interior, preferably comprised of metal, such as steel. In one embodiment, the anchor element 20 is dimensioned to fit within the openings 14 in the mesh 10, with the anchor element 20 element being of lesser axial extent than the cross-section of the opening 14. In this embodiment, the body of the anchor element 20 may be welded to the mesh 10 to secure the anchor element 20 to the mesh 10, as shown in FIG. 3. Because the mesh 10 is embedded and secured within the refractory member 1, securing the anchor element 20 to the mesh 10 can thereby secure the anchor element 20 to the refractory member 1. The anchor element 20 can then be attached to the support element 3 by welding one end of the anchor element 20 to the surface of the support element 3. The axial extent, or diameter, of the hollow interior of the anchor element 20 should be sufficient to allow for a weld rod to be inserted therein to obtain a good structural weld between the anchor 20 and the support element 3.

In another embodiment, shown in FIG. 4, the anchor element 20 is a tubular insert like that disclosed in U.S. patent application Ser. No. 11/870,153 (Klein), published as U.S. Patent Application Publication No, 2008/0084908 A1, the contents of which are expressly incorporated herein by reference. In this embodiment, the anchor element 20 includes a top lip 40 which has an axial dimension greater than the cross-sectional area of the opening 14 in the mesh 10 so that the lip 40 can engage the mesh 10 when the anchor element 20 is inserted into the opening 14. Because the top lip 40 of the anchor element 20 can engage the mesh 10, the anchor element 20 does not need to be welded to the mesh 10 to secure it thereto, but such a weld is possible to better secure the anchor element 20 to the refractory member 1. This anchor element 20 can be attached to the support element 3 of the furnace by a weld or by a bolt, as described in U.S. patent application Ser. No. 11/870,153. For instance, a bolt can be inserted through a hollow interior portion of anchor element 20 so that the bolt head can rest on an internal shelf 50 at the base of the anchor element 20. The bolt can be passed through a hole disposed in the support element 3 and the secured in place through the use of a nut or other appropriate securing device. Regardless of the form of the anchor element 20, by creating a system where the support element 3 contacts the anchor element 20 which engages the mesh 10 embedded within the refractory member 1, heat can more efficiently be dissipated throughout the insulation material 5 of the refractory member 1.

The refractory member 1 may further include at least one receiving space 36. The receiving space 36 may be filled with an insert material 30, such as macroporous insulation, ceramic fiber blanket, paper, felt, etc., in order to further increase the insulation value of the refractory member 1. Materials potentially useful as the insert material 30, alone or in combination, include silica fume, titanium dioxide, or like compounds. One example of a material that can be used as the insert material 30 is BTU-BLOCK 1807, available commercially from Thermal Ceramics, of Augusta, Ga. In one embodiment, insert material 30 is in the form of a monolithic block that can be inserted into the receiving space 36 and secured within receiving space 36 by an adhesive or other appropriate attachment substance.

The refractory member 1 can also be coated with substances which improve the durability of the member at high temperatures. Commercially available examples of useful coatings include those available under the trade names GEMCOHESIVE and RSI 181, both available from Refractory Specialties, Inc. of Sebring, Ohio, WESROCK RFC #17, available from Wesbond Corporation of Wilmington, Del., KA-COAT 40, available from Bloom Engineering of Pittsburgh, Pa., and LADLELOCK, available from United Refractories, Inc. of Warren, Ohio.

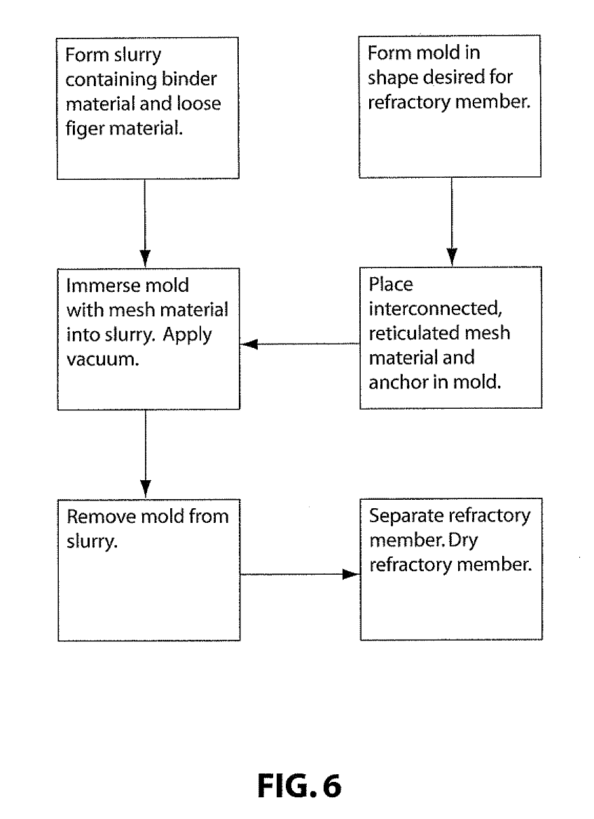

A method of producing the refractory member of the present invention will now be described. This method is also generally summarized in the block diagram of FIG. 6. A slurry of the insulation material and water is formed. The slurry can be formed by combining loose particulates of fibers and powder binders into a mixing chamber along with a sufficient amount of water to fully suspend the fiber and binder materials. A mold is also provided. The interior surface of the mold should conform to the shape desired for the refractory member. The mold is typically made of a metal material but other materials can be used, as would be appreciated by one skilled in the art. In one embodiment, the mold is constructed of a screen-like metal material, comprising many small openings therein. A reticulated, interconnected mesh material corresponding to the shape and dimensions of the interior of the mold is formed and placed within the mold. Optionally, the anchor element can now be placed within the mold and inserted between the openings in the mesh material. Alternatively, the anchor element can be inserted into the refractory member after formation of the member is complete. Anchor element may be welded to mesh if so desired, though such welding will be more difficult if anchor element is only inserted into refractory member after member has been formed.

The mold, with the mesh material and, optionally, the anchor element therein, is then immersed into the slurry. After immersion, a vacuum is applied to the mold. Application of the vacuum causes the solid portions of the slurry material, which include the fiber and binder materials, to build up against the mold surface. If the mold is comprised of a screen-like material, the majority of the liquid portion of the slurry passes through the mold during application of the vacuum while the solid portions of the slurry are trapped against the interior surface of the mold. Application of the vacuum creates a compressed, wet mass of fiber and binder materials that is substantially in the shape of the interior surface of the mold. Embedded within this mass are the reticulated, interconnected mesh material and, optionally, the anchor element, which together form the refractory member. After sufficient time under vacuum, the vacuum is released and the mold is removed from the slurry. Typically, this time period is less than 1 minute, which is sufficient to form a refractory member that is about 2 to 3 inches thick. The refractory member can then be separated from the mold, and the refractory member can be subjected to a drying process to remove any excess water and, if drying is completed at a high enough temperature, certain organic binders. If desired, the refractory member can now be coated with an appropriate coating material.

The present invention will be more readily appreciated with reference to the examples which follow. Importantly, the examples highlight the advantages the refractory member of the present invention has over refractory materials that are available in the art.

### EXAMPLES

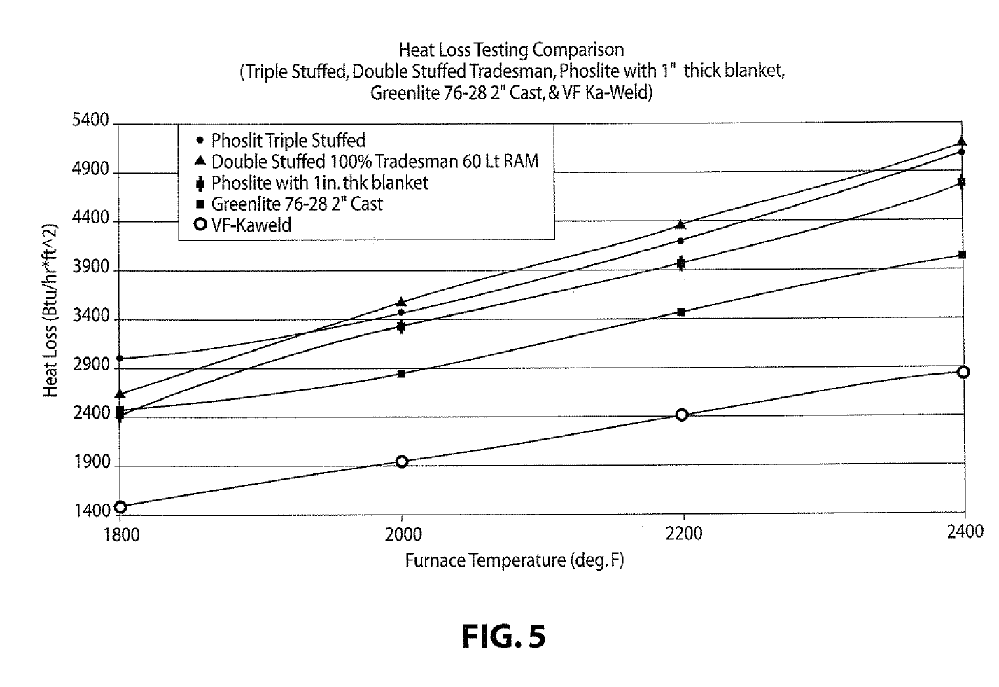

Performance of the refractory member of the present invention was compared with several commercially available refractory materials. The inventive refractory member showed better durability at higher temperature heat soaks. In addition, as shown in FIG. 5, a skid-pipe insulated with refractory members of the present invention experienced less heat loss than skid pipes insulated with currently available refractory materials.

### High-Temperature Durability Tests

The first comparative samples were composed of KAOWOOL, a refractory material commercially available from Thermal Ceramics of Augusta, Ga. KAOWOOL is available as an air-laid, continuous mat or blanket that is mechanically needled together. KAOWOOL blanket is rated for continuous service at 2000° F. To improve the refractoriness of the samples, the holding time was extended and the material was dipped in colloidal silica and dried in a horizontal position to keep the colloidal silica evenly dispersed throughout the material. These samples survived a 2400° F. overnight heat soak, but failed during heat soaking at 2500° F.

The next comparative samples were composed of CERACHEM blanket, a refractory material also commercially available from Thermal Ceramics of Augusta, Ga. CERACHEM blanket, like KAOWOOL blanket, is presented as an air-laid, continuous mat or blanket that is mechanically needled together. CERACHEM blanket is rated at 2400° F. for continuous service and for a maximum temperature of 2600° F. These samples were formed around central KA-PIN mats, available commercially from Bloom Engineering, and subjected to heat soak tests to determine high-temperature durability. After a heat soak at 2500° F., the samples remained in fair condition. During a second heat soak of the material, this time at 2600° F., it was observed that the material remained in solidarity while hot, but during cooling a portion of the material fell off into the furnace.

Refractory members according to the present invention were also tested for durability under high-temperature conditions. A first sample refractory member was formed of an insulation material composed of GEMCOLITE 2600 LD, available commercially from Refractory Specialties, Inc. This material has a composition, by weight, of 55% SiO₂, 15% ZrO₂, 26% Al₂O₃, and 4% of binder materials and other trace elements. A slurry of the insulative material was formed by combining GEMCOLITE 2600 LD with water and mixing the resulting solution at about 70° in a semi-continuous process. A reticulated, interconnected mesh material composed of stainless steel and a metal anchor element were placed inside a screen-like mold. A vacuum was applied to the mold for about 45 seconds at about 70° until a layer of insulating material between about 2 and 3 inches thick was formed along the interior surface of the mold. The formed refractory member and mold were then removed from the slurry and the refractory member was separated from the mold and subsequently dried. The member was coated with KA-COAT 40, available commercially from Bloom Engineering of Pittsburgh, Pa., and subjected to a heat soak at 2500° F. for 72 hours. After completion of the heat soak, the outer coating was found to have cracked and partially flaked off. However, the underlying refractory material remained completely undamaged absent a few minor cracks.

In another example, a refractory member of the present invention which had already undergone heat loss testing was subjected to testing for high-temperature durability. This refractory member was also composed of GEMCOLITE 2600 LD and formed according to the vacuum-formed method described above with respect to the previous sample. After formation, this sample member was coated with LADLELOCK, and heat soaked for 72 hours at 2600° F. The LADLELOCK coating material experienced problems with swelling and pulling away from the refractory member underneath.

Another inventive sample refractory member composed of GEMCOLITE 2600 LD coated with GEMCOHESIVE RS-360 F was tested. This refractory member was heat soaked at 2500° F. for 72 hours. The GEMCOHESIVE coating layer did not crack and stayed intact on the member.

### Heat Loss Testing

A refractory member of the present invention was also tested to determine its performance in limiting heat loss from a skid pipe compared with other refractory materials. The results of these tests are shown in FIG. 5.

The test was conducted by fitting various refractory materials around a 3 inch I.P.S. skid pipe, placed inside a high temperature furnace, through which water was flowing at about 80° F. with a flow rate of between about 500 and 1000 gallons per hour. The temperature in the furnace was then ramped-up to a maximum of 2400° F. At furnace temperatures of 1800° F., 2000° F., 2200° F., and 2400° F., the heat loss value, a measure of the amount of energy transferred through each square foot of the refractory material, was measured by thermistor sensors and water flow meters. The results were plotted and the resulting graph is presented as FIG. 5.

The comparative samples tested for heat loss were:

PHOSLITE Triple Stuffed, commercially available from Bloom Engineering of Pittsburgh, Pa.;

Double Stuffed 100% Tradesman 60 Lt RAM, available commercially from Bloom Engineering;

PHOSLITE with 1″ thick blanket; and

GREENLITE 76-28 2″ castable.

The refractory member of the present invention, labeled on FIG. 5 as “VF-KaWeld,” was comprised of vacuum formed KAOWOOL ceramic fibers rated for 2300° F. hardened with a colloidal silica binder. No external coating was supplied to this sample.

As can be seen in FIG. 5, the skid pipe insulated with a refractory member of the present invention exhibited less heat loss at each of the tested temperature values than a skid pipe insulated with conventional refractory materials.

The above examples show that refractory members of the present invention provide superior heat loss and heat degradation characteristics when compared to conventional refractory materials.

In addition, refractory members of the present invention formed through the vacuum process described above are much lighter in weight than refractory materials formed from previously employed pressing Methods. For example, refractory members constructed by a convention pressing method have a typical density value of between 90 and 160 pounds per cubic foot (pcf) while refractory members constructed according to the method of the present invention have a typical density value of between about 10 and 35 pcf Lighter weight members provide many advantages in the art, including lower shipping costs and greater ease in installation. In addition, refractory members of the present invention can be made much faster, reducing the labor costs associated with such products.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. A protective refractory member, comprising:
a vacuum-formed refractory shape comprising a fibrous material and at least one binder material;
an interconnected, reticulated mesh material embedded in the refractory shape; and
an anchor element embedded in the refractory shape.

2. The refractory member of claim 1, wherein the anchor element engages the mesh material.

3. The refractory member of claim 2, wherein the anchor element is welded to the mesh material.

4. The refractory member of claim 2, wherein the anchor element comprises a lip member, and the lip member engages the mesh material.

5. The refractory member of claim 1, wherein the fibrous material is a material selected from the group consisting of silica, zirconia, alumina, silica-alumina, and combinations thereof.

6. The refractory member of claim 1, wherein the binder material is an inorganic binder material.

7. The refractory member of claim 1, wherein the density of the refractory member is between 10 and 35 pounds per cubic foot.

8. The refractory member of claim 1, further comprising a coating material applied to at least a portion of an exterior surface of the refractory member.

9. The refractory member of claim 1, further comprising at least one receiving space filled with an insert material.

10. The refractory member of claim 9, wherein the insert material is in the form of a monolithic block.

11. A method of manufacturing a refractory member, comprising the steps of:
providing a mold;
placing an interconnected, reticulated mesh material within the mold;
forming a slurry comprising a loose fiber material and at least one binder material;
immersing the mold and mesh material in the slurry;
subjecting the immersed mold to a vacuum for a time sufficient to form a refractory member substantially conforming to the shape of the mold;
removing the mold and refractory member from the slurry;
separating the refractory member from the mold; and
drying the refractory member.

12. The method of claim 11, wherein the vacuum is applied for less than 1 minute.

13. The method of claim 11, further comprising the step of placing an anchor element between openings in the mesh material before subjecting the immersed mold to a vacuum.

14. The method of claim 11, further comprising the step of placing an anchor element between openings in the mesh material after subjecting the immersed mold to a vacuum.

15. The method of claim 11, further comprising the step of applying a coating to at least a portion of an exterior surface of the refractory member.

16. The method of claim 11, wherein the mold is comprised of a metal screen material.

17. A system for insulating a support member in a high-temperature furnace, the system comprising:
a protective refractory member, comprising:
a vacuum-formed refractory shape comprising a fibrous material and at least one binder material;
an interconnected, reticulated mesh material embedded in the refractory shape; and
an anchor element embedded in the refractory shape,
wherein the anchor element is secured to the support member.

18. The system of claim 17, wherein the anchor element is secured to the support member by a weld.

19. The system of claim 17, wherein the anchor element is secured to the support member by a bolt.

20. The system of claim 17, wherein the protective refractory member further comprises at least one receiving space filled with an insert material.
